(19) United States
(12) Patent Application Publication
(10) Pub. No.: US 2015/0136523 A1
(43) Pub. Date: May 21, 2015

(54) TORSION PLATE FOR LADDER

(71) Applicant: Caterpillar Inc., Peoria, IL (US)

(72) Inventors: Robert J. Madera, Lemont, IL (US); Joshua C. Bedyk, Sandwich, IL (US); Christopher P. Cherwin, Yorkville, IL (US); John M. Teter, North Aurora, IL (US)

(73) Assignee: Caterpillar Inc., Peoria, IL (US)

(21) Appl. No.: 14/082,498

(22) Filed: Nov. 18, 2013

(51) Int. Cl. E06C 5/04; E04G 5/14

(52) U.S. Cl. CPC E06C 5/04; E04G 5/14
USPC 182/113; 182/127

(57) ABSTRACT

A ladder is provided. The ladder includes a frame having a first side wall and a second side wall. The first and second side walls are connected by a plurality of steps. The plurality of steps is provided in an axially spaced apart arrangement relative to each other. The ladder also includes an actuator coupled to the frame. The actuator is configured to provide a rotary movement to the frame for positioning the ladder in any one of a deployed position and a stowed position. The ladder further includes a torsion plate. The torsion plate is provided on the frame in cooperation with the actuator. The torsion plate is configured to transfer at least a portion of a torque associated with the rotary movement from the first side wall to the second side wall.

### TECHNICAL FIELD

The disclosure relates to a ladder, and more specifically the ladder provided at access points for mounting a machine.

### BACKGROUND

Ladders or stairways are provided on machines to allow an operator or other personnel to climb onto the machine. On large sized machines, such as, a large wheel loader or a track type tractor, a vertical ladder may be provided on a bumper of the machine for allowing the operator to mount the machine. However, as an overall height of the machine increases, a distance between the bumper from ground level may also increase. Hence, a longer vertical ladder may be required to climb onto the machine. It may become cumbersome for a person to climb the vertical ladder and/or transport tools up the vertical ladder. Some machines include large stairways extending or protruding from the bumper of the machine at an angle. However, it may be difficult to operate the machine with the stairway protruding from a side of the machine.

Rotatable stairways have been coupled to a drive system on-board the machine. The drive system may be used for rotating the stairway. The drive system includes a shaft driven by a pump and a cylinder. The shaft runs across a width of the stairway, the shaft being positioned between adjacent steps of the stairway. Also, the drive system may be heavy, causing an overall increase in a weight of an assembly of the stairway and the drive system.

U.S. Pat. No. 5,996,737 discloses an access device for providing access between a lower level and an upper level. The device includes a platform member, a ladder member and a rotating actuator. The platform and the ladder are movable between an access position wherein the ladder is positioned downwardly and the platform is horizontal, and, a storage position, in which the ladder is positioned upwards and the platform is vertical. In a first step, the actuator rotates the ladder through about a 90 degree angle to an intermediate position at which time the ladder engages with the platform. Then, in a second step, the ladder and platform cooperatively rotate between the intermediate position and the stored position.

### SUMMARY OF THE DISCLOSURE

In one aspect of the present disclosure, a ladder is provided. The ladder includes a frame having a first side wall and a second side wall. The first and second side walls are connected by a plurality of steps. The plurality of steps is provided in an axially spaced apart arrangement relative to each other. The ladder also includes an actuator coupled to the frame. The actuator is configured to provide a rotary movement to the frame for positioning the ladder in any one of a deployed position and a stowed position. The ladder further includes a torsion plate. The torsion plate is provided on the frame in cooperation with the actuator. The torsion plate is configured to transfer at least a portion of a torque associated with the rotary movement from the first side wall to the second side wall.

In another aspect of the present disclosure, a ladder is provided. The ladder includes a frame. The frame of the ladder includes a base plate. The frame also includes a first side wall and a second side wall. The second side wall of the frame is laterally spaced apart from the first side wall. The frame also includes a plurality of steps coupled to the base plate, the first side wall and the second side wall. The plurality of steps is provided in an axially spaced apart arrangement relative to each other. The ladder also includes an actuator coupled to the first side wall. The actuator is configured to provide a rotary movement to the frame for positioning the ladder in any one of a deployed position and a stowed position. The ladder further includes a torsion plate connected to the first side wall and the second side wall. The torsion plate is axially aligned relative to the actuator. Further, the torsion plate is configured to transfer at least a portion of a torque associated with the rotary movement from the first side wall to the second side wall.

In yet another aspect of the present disclosure, a machine is provided. The machine includes an engine, a work implement and a chassis. The machine further includes a frame member coupled to the chassis. A ladder is rotatably coupled to the frame member. The ladder includes a frame having a first side wall and a second side wall. The first and second side walls are connected by a plurality of steps. The plurality of steps is provided in an axially spaced apart arrangement relative to each other. The ladder also includes an actuator coupled to the frame. The actuator is configured to provide a rotary movement to the frame for positioning the ladder in any one of a deployed position and a stowed position. The ladder further includes a torsion plate provided on the frame in cooperation with the actuator. The torsion plate is configured to transfer at least a portion of a torque associated with the rotary movement from the first side wall to the second side wall

Other features and aspects of this disclosure will be apparent from the following description and the accompanying drawings.

### BRIEF DESCRIPTION OF THE DRAWINGS

FIG. 1 is a perspective view of a section of an exemplary machine showing a ladder mounted thereon, according to one embodiment of the present disclosure;

FIG. 2 is a perspective view of the ladder in a deployed position;

FIG. 3 shows an enlarged view of a torsion plate of the ladder;

FIG. 4 shows an exploded view of a rotary actuator and a first hub coupled to a side wall of the ladder;

FIG. 5 shows an exploded view of a second hub and bearings coupled to another side wall of the ladder; and

FIG. 6 is a perspective view of the section of the machine showing the ladder in a stowed position thereon.

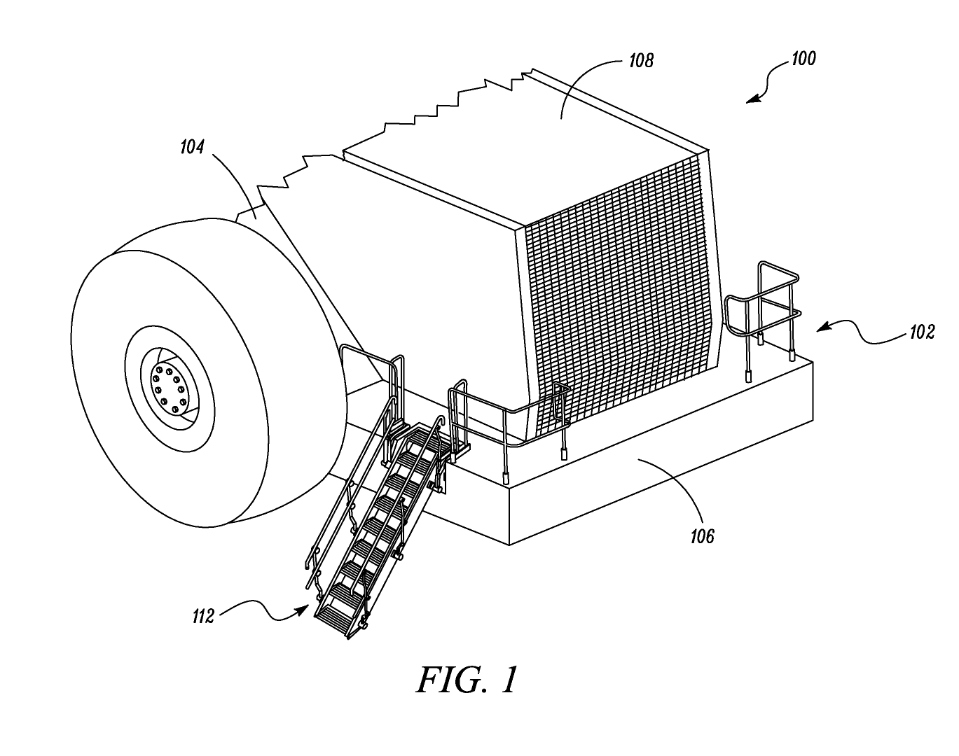

### DETAILED DESCRIPTION

Wherever possible, the same reference numbers will be used throughout the drawings to refer to the same or the like parts. FIG. 1 illustrates a section of an exemplary machine 100 according to one embodiment of the present disclosure. As illustrated, the machine 100 may embody a large wheel loader. Alternatively, the machine 100 may include, but not limited to, a backhoe loader, a skid steer loader, a track type tractor, a motor grader and the like. It should be understood that the machine 100 may embody any wheeled or tracked machine associated with mining, agriculture, forestry, construction, and other industrial applications.

The machine 100 includes a front section (not shown) and a rear section 102. The machine 100 has a chassis 104. A frame member 106 is coupled to the chassis 104 of the machine 100. As shown in the accompanying figures, the frame member 106 may be embodied as a bumper 106. Alternatively, the frame member 106 may include a platform or any support structure attached to the chassis 104 of the machine 100. An engine enclosure 108 is mounted on the chassis 104 of the machine 100. An engine may be housed within the engine enclosure 108. The engine may generate the necessary driving power required by the machine 100. In one embodiment, the engine may include, for example, a diesel engine, a gasoline engine, a gaseous fuel powered engine like a natural gas engine, or any other known source of power.

The machine 100 may also include a work implement (not shown) for performing activities such as, transportation of material from one place to another. In one embodiment, the work implement may include a lifting assembly (not shown) having a lift arm (not shown), a support arm (not shown) and a bucket (not shown). The bucket of the lifting assembly may be configured to collect, hold and convey the material and/or object on a ground. A hydraulic system (not shown) may be used to effectuate the movement of the lift arm, the support arm and/or the bucket of the lifting assembly.

A transmission system (not shown in figures) may include coupling elements configured to transmit a drive torque from the engine to a propelling system (not shown). The propelling system may include a plurality of wheels driven by a differential gearing for propelling the machine 100 over the ground. The work implement described herein, is merely exemplary and does not limit the scope of the present disclosure. Further, the machine 100 may include an operator cabin (not shown). The operator cabin may include a plurality of input devices (not shown) configured to control and operate the machine 100 and/or the work implement.

Ladders or stairways 112 may be provided at different access points on the machine 100 for allowing personnel such as, an operator or maintenance staff, to mount the machine 100 for the purpose of operating or servicing the machine 100. The access points may be located, for example, on any one or both sides of the bumper 106 provided on the front section and/or the rear section 102 of the machine 100. In the accompanying figures, the ladder 112 is provided at the rear section 102 of the machine 100.

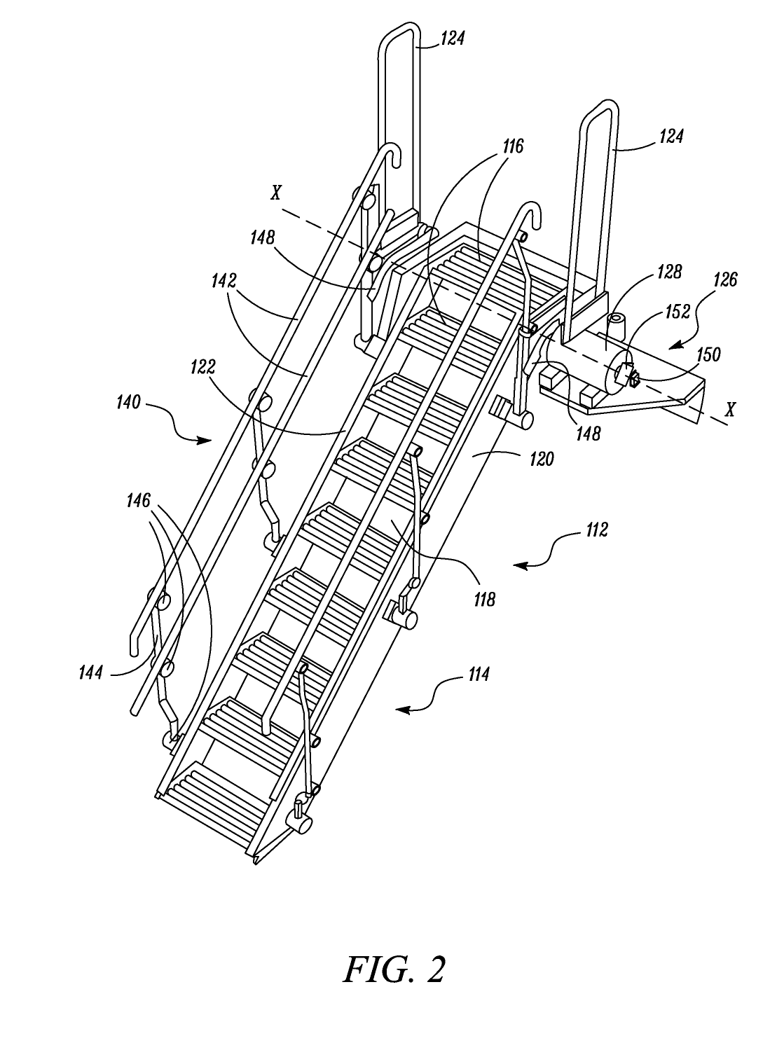

The ladder 112 shown in FIGS. 1 and 2 is in a deployed position, such that one end of the ladder 112 extends towards the ground and the other end of the ladder 112 is coupled to the bumper 106 of the machine 100. Referring to FIG. 1, a portion or an upper section of the ladder 112 may be embedded within the bumper 106 of the machine 100. Parts or components of the ladder 112 will now be described in detail with reference to FIGS. 2 to 5. FIG. 2 illustrates a perspective view of the ladder 112 when in the deployed position.

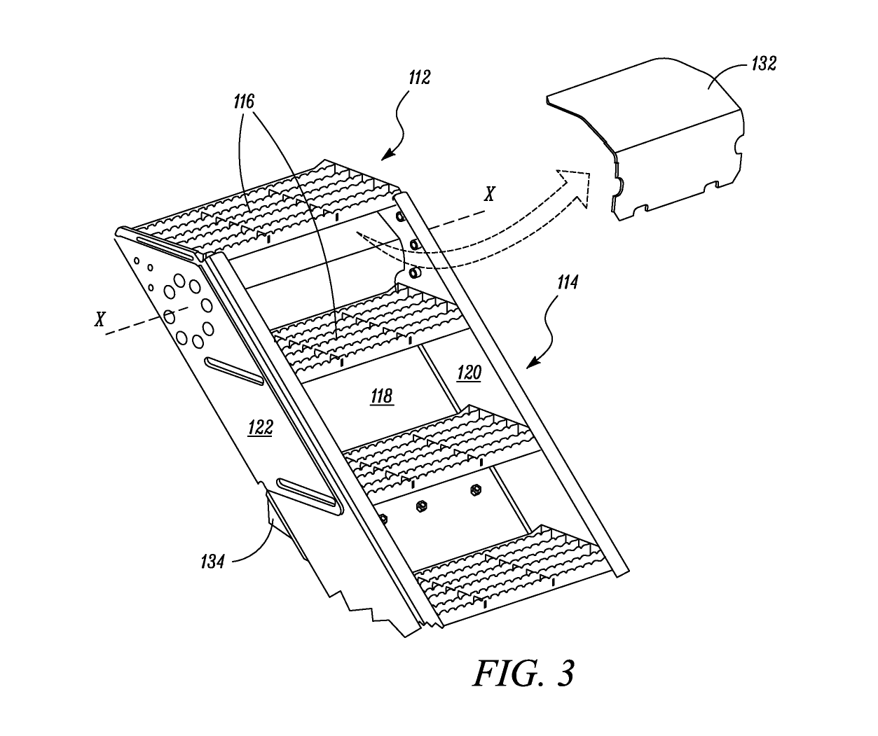

The ladder 112 includes a frame 114 and a plurality of steps 116 attached to the frame 114. The steps 116 are spaced apart from each other in an axial direction. FIG. 3 illustrates the frame 114 of the ladder 112 and the steps 116. The frame 114 of the ladder 112 may include a base plate 118, and a first side wall 120 and a second side wall 122 extending upwardly from either sides of the base plate 118. The frame 114 may have a single piece design with a U-shaped cross-section. The steps 116 may have a corrugated design. As shown, a width of the steps 116 may be equal to a width of the first and second side walls 120, 122. The steps 116 may be affixed to the first and second side walls 120, 122 and/or the base plate 118 of the ladder 112. A portion of the first and second side walls 120, 122 may partially enclose the steps 116 for securely holding the steps 116 in place with respect to the frame 114 of the ladder 112. The design of the frame 114 and the steps 116 disclosed herein are exemplary and may vary without deviating from the scope of the present disclosure. Referring to FIG. 2, two U-shaped holding bars 124 may be provided near the upper section of the ladder 112 for providing support to the operator when using the ladder 112 to board or alight from the machine 100.

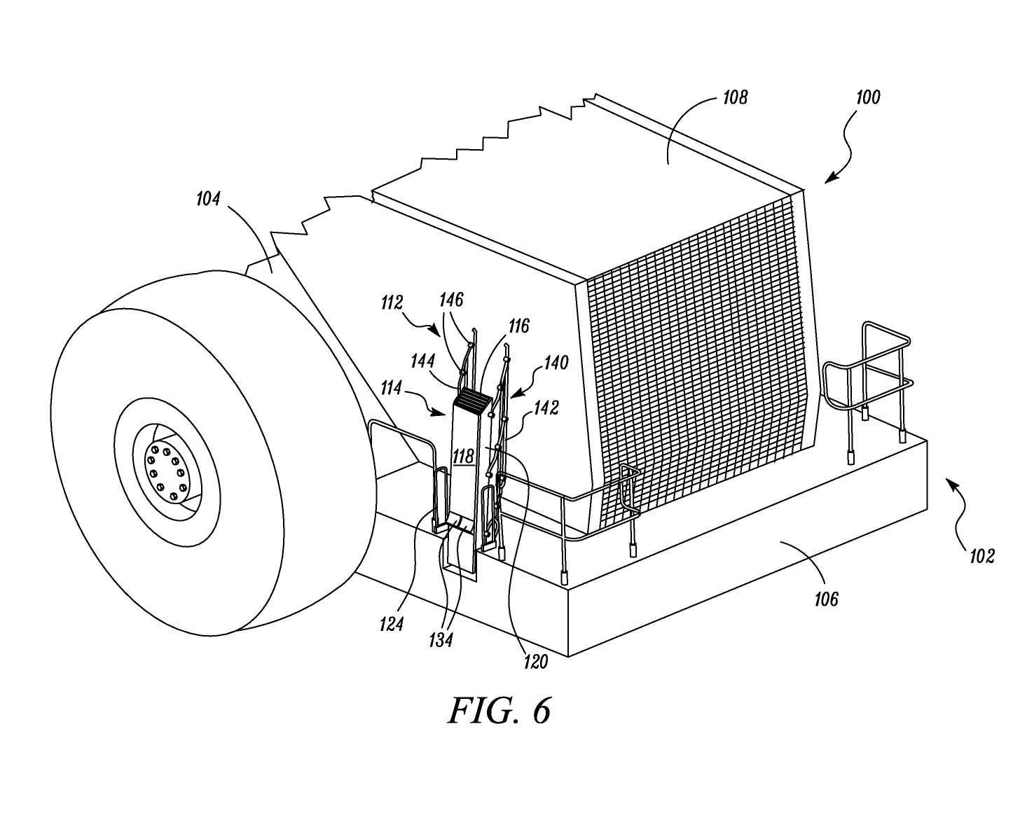

A drive assembly 126 may be coupled to the ladder 112 in order to rotate the ladder 112 with respect to the chassis 104 of the machine 100. The drive assembly 126 may be used to position the ladder 112 in the deployed position (shown in FIGS. 1 and 2) or a stowed position (shown in FIG. 6) with respect to the machine 100. The drive assembly 126 may be coupled to the upper section of the ladder 112. Further, the drive assembly 126 may be embedded within the bumper 106 of the machine 100. The drive assembly 126 may be operated hydraulically. For example, the drive assembly 126 may include a self-contained hydraulic system such that the drive assembly 126 may provide a torque for the rotation of the ladder 112 even when the machine 100 is in a non-operating state. Alternatively, the drive assembly 126 may be operated pneumatically.

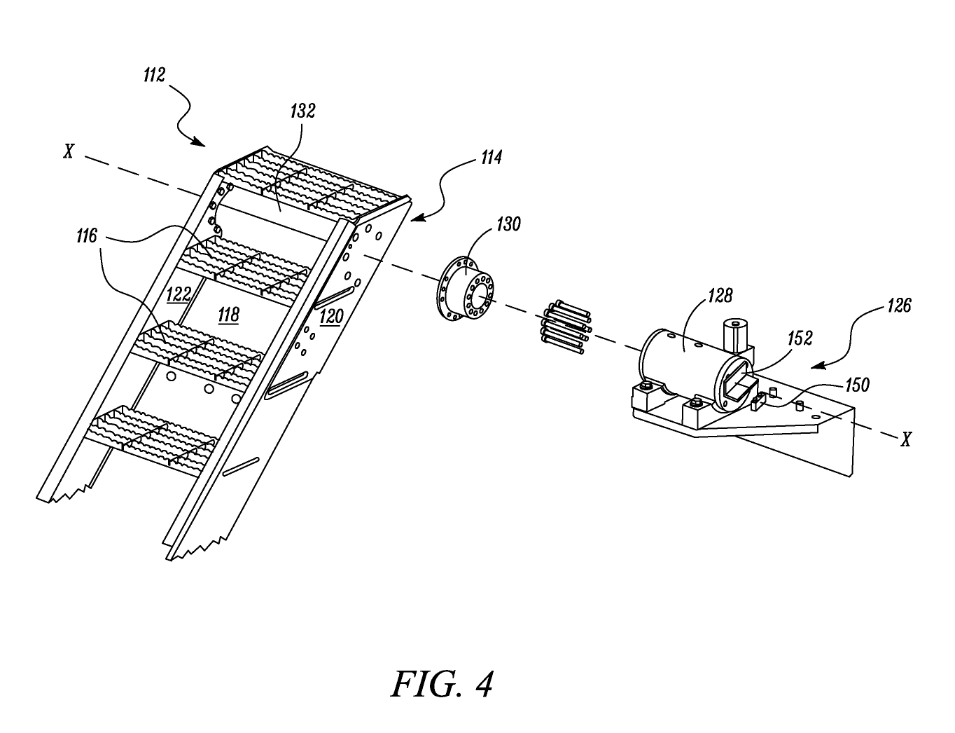

Referring to FIGS. 2 and 4, the drive assembly 126 may include an actuator 128 rotatably coupled to any one of the side walls 120, 122 of the frame 114. In the accompanying figures, the actuator 128 is coupled to the first side wall 120 of the ladder 112. The actuator 128 may be an electric motor, a pneumatic actuator, a hydraulic piston, a relay, a comb drive, a piezoelectric actuator, a thermal bimorph, a digital micromirror device, an electroactive polymer and the like.

The actuator 128 is configured to provide the rotary movement to the ladder 112 such that the ladder 112 may pivot about an axis X-X defined by the actuator 128. Based on an actuation signal provided to the actuator 128, the ladder 112 may either be rotated to the deployed position or the stowed position. The actuation signal may be provided to the actuator 128 by the operator via the input device present within the operator cabin. In some embodiments, the location of the input device may vary, for example, the input device may be off-board the machine 100. The input device may be a remote controlled device wirelessly coupled to the actuator 128, such that the input device may be easily accessed from outside of the machine 100, prior to mounting the machine 100. Alternatively, the input device may be a control panel affixed to the bumper 106 of the machine 100, to allow the operator to control a position of the ladder 112 prior to mounting the machine 100.

As shown in FIGS. 2 and 4, the actuator 128 may be coupled to the upper section of the ladder 112. FIG. 4 is an exploded view of the actuator 128 and a first hub 130 coupled to one side of the ladder 112. A first end of the first hub 130 may be coupled to the frame 114 of the ladder 112 and a second end of the first hub 130 may be coupled to the actuator 128. The first hub 130 may be coupled to the frame 114 of the ladder 112 using any known methods for example, using mechanical fasteners. On receiving the actuation signal, the actuator 128 may power the first hub 130. This may cause the first hub 130 to exert the torque on the first or second side walls 120, 122 of the ladder 112 to which the hub 130 is attached.

A torsion plate 132 (shown in FIG. 3) is provided on the frame 114 of the ladder 112 and in cooperation with the actuator 128. The torsion plate 132 is configured to transfer at least a portion of the torque associated with the rotary movement from the first side wall 120 to the second side wall 122 of the ladder 112. The torsion plate 132 may provide rigidity and torsional stiffness to the ladder 112. It should be noted that the torsion plate 132 and the frame 114 of the machine 100 may be made of any metal or polymer known in the art. The material may be chosen such that it is light weight and provides stiffness and rigidity to the ladder 112.

As shown in FIGS. 2, 4 and 5, the torsion plate 132 may be aligned along the axis X-X of the actuator 128. Accordingly, the torsion plate 132 may be positioned at the upper section of the ladder 112. The torsion plate 132 may be placed between adjacent steps 116 of the ladder 112. The torsion plate 132 may be positioned between the first and second side walls 120, 122 of the frame 114 and attached to the base plate 118 of the frame 114. The torsion plate 132 may be coupled to the first and second side walls 120, 122 such that a width of the torsion plate 132 measured in the direction of the axis X-X may be equal to the width of the steps 116. When the first hub 130 coupled to the actuator 128 provides the torque to the first side wall 120 of the ladder 112 for rotating the ladder 112, the torsion plate 132 is configured to provide a surface for the transfer of the torque from the first side wall 120 to the second side wall 122. This may allow for a distribution of the torques on both sides of the ladder 112, thereby allowing for the ladder 112 to rotate about the axis X-X.

As shown in FIG. 3, the torsion plate 132 may be at least partially curved. The curvature of the torsion plate 132 may be such that the torsion plate 132 may fit within a gap provided between the adjacent steps 116 of the ladder 112. This shape of the torsion plate 132 may prevent collection of dirt or debris on a surface of the torsion plate 132. Alternatively, in another embodiment, the torsion plate 132 may embody planar surfaces attached to each other using any known method. For example, the torsion plate 132 may include two flat plates welded together.

In an embodiment wherein the base plate 118 is missing, the torsion plate 132 may include a second torsion plate 132 similar to that shown in FIG. 3, such that the two torsion plates 132 may form a substantially cylindrical structure having a radius equal to that of the width of the gap between the adjacent steps 116. The torsion plate 132 may be attached to the frame 114 of the ladder 112 by welding, riveting, screwing or using any other known method. However any other means of attachment may be used to attach the torsion plate 132 to the frame 114.

Additionally, angular brackets 134 (shown in FIG. 6) may be provided on a rear side of the base plate 118 of the frame 114 of the ladder 112. The angular brackets 134 may be provided proximate to the upper section of the ladder 112. For example, two angular brackets 134 may be provided between adjacent steps 116, such that the angular brackets 134 are placed next to each other. The angular brackets 134 may be configured to provide a contact surface for the ladder 112 against the bumper 106, when the ladder is in the deployed position. The angular brackets 134 may also be configured to withstand twisting stresses transferred from the upper section to a lower section of the ladder 112.

The angular brackets 134 may allow the twisting stresses to bypass the steps 116 and thus provide a robust design.

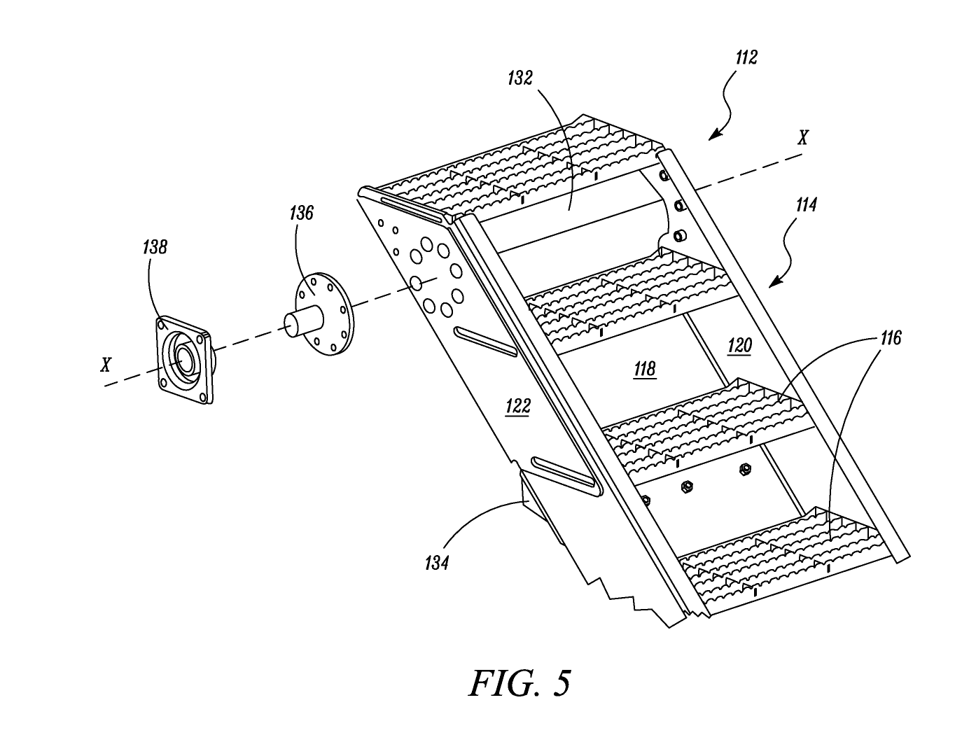

Referring to FIG. 5, a second hub 136 may be coupled to the second side wall 122 of the frame 114. The second hub 136 may have a disc shaped configuration and a pin extending therefrom. The second hub 136 may be attached to the second side wall 122 of the ladder 112 using mechanical fasteners. The pin of the second hub 136 may be received by a bearing 138 rotatably coupled to the second hub 136. The bearing 138 may be fixedly supported within the bumper 106 of the machine 100 such that the frame 114 of the ladder 112 may pivot about the bearing 138, the second hub 136 and the first hub 130 of the drive assembly 126.

Referring to FIGS. 1, 2 and 6, a handrail assembly 140 may be coupled to the ladder 112. The handrail assembly 140 may be attached to each of the first and second side walls 120, 122. The handrail assembly 140 may provide support and prevent the operator from falling off the ladder 112 while climbing onto the machine 100. The handrail assembly 140 may include one or more bars 142 extending along at least a portion of a length of the ladder 112.

In the illustrated embodiment, the handrail assembly 140 includes two bars 142 disposed parallel to each other on either side of the ladder 112. A plurality of arms 144 may connect the bars 142 to the first and second side walls 120, 122 of the frame 114. Further, the plurality of arms 144 may extend from the bars 142 to the first and second side walls 120, 122. Each arm 144 may include multiple pivot connections 146. The multiple pivot connections 146 are provided so that the bars 142 and the aims 144 may expand or collapse with respect to the frame 114 of the ladder 112 when the ladder 112 is in the deployed position or the stowed position respectively. For example, as shown, each arm 144 may include three pivot connections 146.

The handrail assembly 140 may be connected to the bumper 106 of the machine 100 through a plate 148. One end of the plate 148 may be connected to the holding bar 124. Another end of the plate 148 may be connected to the arms 144 of the handrail assembly 140. The positioning of the plate 148 may be such that when the ladder 112 rotates about the axis X-X, the arms 144 of the handrail assembly 140 may pivot about the plate 148, causing the handrail assembly 140 to collapse or expand with respect to the frame 114 of the ladder 112 as the case may be.

FIG. 6 shows the ladder 112 in the stowed position. In the stowed position, the frame 114 of the ladder 112 may be substantially perpendicular to the axis X-X. When in the stowed position, the bars 142 may rotate about the pivot connections 146 provided thereon, thereby allowing the handrail assembly 140 to collapse against the frame 114 of the ladder 112, and the ladder 112 in turn to collapse against the chassis 104 of the machine 100. The collapsible handrail assembly 140 may provide a compact ladder design thereby providing space between the ladder 112 and the engine enclosure 108 of the machine 100 for passage of the operator there through.

In one embodiment, a limit switch 150 may be provided in connection to a member 152 (see FIGS. 2 and 4). The limit switch 150 may either be activated or deactivated by the member 152 based on the stowed position or the deployed position of the ladder 112 respectively. The limit switch 150 may be coupled to an output device such that based on the activation or deactivation of the limit switch 150, an indication of the position of the ladder 112 may be provided to the operator via the output device. For example, when the ladder 112 moves from the deployed position to the stowed position, the actuator 128 and the member 152 rotate, causing the activation of the limit switch 150. Accordingly, an indicator light may glow, indicating to the operator that the ladder 112 is in the stowed position.

### INDUSTRIAL APPLICABILITY

The ladder 112 disclosed herein has a single piece design. A weight of the frame 114 may be comparatively reduced because of the single piece design. The handrail assembly 140 is structured such that the stresses at a pivot end of the handrail assembly 140 may be reduced, providing a construction which may be rigid and robust.

The torsion plate 132 is configured to transfer the torque from the first side wall 120 to the second side wall 122 of the ladder 112. The torsion plate 132 may provide torsional stiffness and rigidity to the ladder 112. The torsion plate 132 may be light in weight and provides a compact and cost effective design. The curvature of the torsion plate 132 is such that the accumulation of dirt/debris may be prevented. The positioning of the torsion plate 132 in the gap between the adjacent steps 116 of the ladder 112 may prevent the operator's leg from being caught in the gap.

The drive assembly 126 and a portion of the ladder 112 may be embedded within the bumper 106 of the machine 100 such that ladder 112 does not protrude from the chassis 104 of the machine 100. The handrail assembly 140 may collapse about the multiple pivot connections 146 in order to provide better access to the operator or maintenance staff. Hence, the compact design of the ladder 112 may reduce or prevent obstruction to other activities performed by the machine 100.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A ladder comprising:
a frame having a first side wall and a second side wall, the first side wall and the second side wall connected by a plurality of steps, the plurality of steps provided in an axially spaced apart arrangement relative to each other;
an actuator coupled to the frame, the actuator configured to provide a rotary movement to the frame for positioning the ladder in any one of a deployed position and a stowed position; and
a torsion plate provided on the frame in cooperation with the actuator, the torsion plate configured to transfer at least a portion of a torque associated with the rotary movement from the first side wall to the second side wall.

2. The ladder of claim 1, wherein the torsion plate is aligned along an axis of the actuator.

3. The ladder of claim 1, wherein the torsion plate is at least partially curved.

4. The ladder of claim 1, wherein the torsion plate is configured to be positioned between adjacent steps.

5. The ladder of claim 1, wherein a width of the torsion plate is equal to a width of the step.

6. The ladder of claim 1, wherein the torsion plate is positioned at an upper section of the frame.

7. The ladder of claim 1, wherein the torsion plate is attached to a base plate of the frame.

8. The ladder of claim 1 further comprising:
a first hub coupled to the frame and the actuator.

9. The ladder of claim 8 further comprising:
a second hub coupled to the frame; and
a bearing rotatably coupled to the second hub.

10. The ladder of claim 1 further comprising:
a handrail coupled to the frame, wherein the handrail includes multiple pivot connections configured to allow the handrail to expand when in the deployed position and collapse when in the stowed position.

11. The ladder of claim 1, wherein the torsion plate is made of a metal.

12. A ladder comprising:
a frame comprising:
a base plate;
a first side wall;
a second side wall laterally spaced apart from the first side wall; and
a plurality of steps coupled to the base plate, the first side wall and the second side wall, the plurality of steps provided in an axially spaced apart arrangement relative to each other;
an actuator coupled to the first side wall, the actuator configured to provide a rotary movement to the frame for positioning the ladder in any one of a deployed position and a stowed position; and
a torsion plate connected to the first side wall and the second side wall, the torsion plate axially aligned relative to the actuator, wherein the torsion plate is configured to transfer at least a portion of a torque associated with the rotary movement from the first side wall to the second side wall.

13. The ladder of claim 12, wherein the torsion plate is at least partially curved.

14. The ladder of claim 12 further comprising:
a handrail coupled to the frame, wherein the handrail includes multiple pivot connections configured to allow the handrail to expand when in the deployed position and collapse when in the stowed position.

15. A machine comprising:
a work implement;
a chassis;
a frame member attached to the chassis; and
a ladder rotatably coupled to the frame member, the ladder comprising:
a frame having a first side wall and a second side wall connected by a plurality of steps, the plurality of steps provided in an axially spaced apart arrangement relative to each other;
an actuator coupled to the frame, the actuator configured to provide a rotary movement to the frame for positioning the ladder in any one of a deployed position and a stowed position; and
a torsion plate provided on the frame in cooperation with the actuator, the torsion plate configured to transfer at least a portion of a torque associated with the rotary movement from the first side wall to the second side wall.

16. The machine of claim 15, wherein the torsion plate is aligned along an axis of the actuator.

17. The machine of claim 15, wherein the torsion plate is configured to be positioned between two adjacent steps

18. The machine of claim 15, wherein at least a portion of the ladder is embedded in the frame member of the machine.

19. The ladder of claim 15, wherein the actuator is embedded in the frame member.

20. The machine of claim 15 further comprising:
a handrail coupled to the frame and the frame member, wherein the handrail includes multiple pivot connections configured to allow the handrail to expand in the deployed position and collapse in the stowed position.
